(19) United States
(12) Patent Application Publication
(10) Pub. No.: US 2015/0245637 A1
(43) Pub. Date: Sep. 3, 2015

(54) AUTOMATIC MACHINE FOR PRODUCTION AND DISPENSING OF SOFT ICE-CREAM

(71) Applicant: Pierluigi Bocchini, Jesi (AN) (IT)

(72) Inventor: Pierluigi Bocchini, Jesi (AN) (IT)

(73) Assignee: CLA.BO.FIN.-S.R.L., JESI(AN) (IT)

(21) Appl. No.: 14/433,749

(22) PCT Filed: Nov. 27, 2012
(86) PCT No.: PCT/EP2012/073732

§ 371 Date: Apr. 6, 2015

(30) Foreign Application Priority Data
Oct. 5, 2012 (IT) AN2012U000066

(51) Int. Cl. A23G 9/28

(52) U.S. Cl. CPC A23G 9/281

(57) ABSTRACT

An automatic machine for production and dispensing of soft ice-cream is disclosed, comprising a work top with longitudinal direction (y-y), a back side for operators in charge of ice-cream dispensing and a front side for customers. The automatic machine also has a plurality of refrigerated tanks connected to whipping cylinders with spiral configuration, having longitudinal axis (x-x) lying on a vertical plane parallel to said longitudinal direction (y-y) of the work top.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present patent application for industrial invention relates to an automatic machine for production and dispensing of soft ice-cream.

2. Description of Related Art Including Information Disclosed Under 37 CFR 1.97 and 37 CFR 1.98.

The peculiarities and advantages of the present invention will become evident after a short description of the prior art.

As it is known, the expression “soft ice-cream” normally refers to a kind of ice-cream consisting in a soft, rather fluid cream, generally dispensed in the form of soft spirals, which is additionally characterized in that it is produced instantaneously and expressly for each single consumption.

The production of soft ice-cream is entrusted to specific machines provided with refrigerated tanks adapted to be loaded with liquid mixtures, preferably obtained with fresh pasteurized products, which will originate different ice-cream flavors.

Said machines are provided with two or more nozzles for dispensing said ice-cream spirals; it being also provided that each of said nozzles is associated with an actuation lever.

The descending travel of each lever conveys the mixture contained in the refrigerated tank to a device defined as “whipping cylinder”, either by gravity or by means of a suitable pump.

Such a whipping cylinder is specifically adapted to produce soft ice-cream and feed it to the dispenser nozzle.

While said ice-cream spirals are dispensed from one of said nozzles, a new mixture dose is automatically transferred from the storage tank to the whipping cylinder, in order to be instantaneously converted into soft ice-cream as soon as a request from the next customer is received.

Referring to such a consolidated technology, it must be noted that the current models of machines used to produce soft ice-cream always have a vertical parallelepiped structure, frontally provided with actuation levers of ice-cream and dispenser nozzles.

Said machines are available in floor or counter models.

In case of a floor model, the machine is practically provided with the structure of a traditional household refrigerator with considerable height and four adjustable ground-support feet; whereas in case of a counter model, the machine has lower height, being adapted to rest on a table or any other suitable supporting structure.

The common feature of the two models consists in the fact that they have a substantially “column” arrangement of internal parts, with mixture storage tanks immediately above said whipping and dispensing units.

In spite of large diffusion, such a technology is impaired by some drawbacks.

In fact, the use of the aforementioned machines causes some inconveniences in terms of the relation between the operator in charge of dispensing soft ice-cream and the customer.

It must be considered that, due to the large volume, said floor machines cannot be coordinated with traditional counters used in bars or ice-cream parlors.

In view of the above, said machines cannot be positioned on the back of said counters, i.e. in the space that is typically occupied by the operator in charge of ice-cream dispensing.

Floor machines are usually positioned at the end of counters or in areas of the shop that are completely separated from said counters.

In such a situation, the operator in charge of dispensing soft ice-cream to customers is forced to operate out of said counters, standing in front of said floor machines and being substantially forced to turn his shoulders to customers, at a very close distance from them.

The fact that the operator in charge of dispensing soft ice-cream turns his back to the customer is not a favorable condition. Moreover, another disadvantageous condition is that the seller and the buyer are very close to each other, without the necessary “separation” space that is guaranteed instead by a traditional counter between customer and operator.

Also the use of compact machines is critical.

While it is true that these machines can be easily coordinated with bar counters, it is also true that they are commonly positioned behind the longitudinal space that is used by operators on the back of the counter.

For this reason, in such a case the operator in charge of dispensing soft ice-cream from compact machines must turn his back to customers who are normally standing in front of the counter.

Even when said compact machine is positioned on the counter, with nozzles facing the “operator” side, it would still be positioned between operator and customer.

This would make visual contact between operator and customer impossible, and would additionally prevent the customer from visually checking the ice-cream dispensing operation, in view of the fact that the customer would only see the back of said machine.

An additional drawback related with the use of traditional dispensing machines of soft ice-cream relates to the fact that the refrigerated tanks with mixtures are inserted inside the supporting structure of the machine and are not visible from the outside.

In view of the above, the customer is not exposed to the suggestion and attraction that are typical of the sale of traditional ice-cream, when the customer's desire to consume ice-cream is certainly increased by the appealing vision of colorful ice-cream tubs with different flavors.

EP 2 181 608 discloses a machine for producing soft ice-cream according to the preamble of claim 1. Said machine comprises a tank containing liquid product disposed above a whipping cylinder.

U.S. Pat. No. 3,811,494 discloses a device for preparation and dispensing soft ice-cream comprising a dispensing container suitable to be located on the service counter of a restaurant and a storage container located below the dispensing container.

Based on similar critical observations on the prior art, the specific purpose of the present invention is to overcome the aforementioned drawbacks.

### BRIEF SUMMARY OF THE INVENTION

In particular, the first purpose of the present invention is to create an automatic machine for production and dispensing of soft ice-cream that for the first time allows the operator to serve customers without turning his back, while still having a suitable separation space.

The second purpose of the present invention is to allow customers to see the tanks used to store liquid mixtures of pasteurized products for production of soft ice-cream.

In this way, consumers can see the contents of said tanks and be exposed to the suggestion of the colors used to distinguish the various mixtures used to produce various flavors.

These purposes are achieved with a new automatic machine for production and dispensing of soft ice-cream, wherein the traditional parts for production and dispensing of soft ice-cream are positioned in a completely new arrangement.

As mentioned above, according to traditional machines, the refrigerated tanks of mixtures of pasteurized liquid products are mounted immediately above said whipping cylinders.

Instead, according to the present invention, said tanks of mixtures are mounted under the surface of the automatic machine of the invention, whereas said whipping and dispensing units are mounted in a vertical structure (a sort of tower) shortly protruding upwards from the surface of the automatic machine and supporting the traditional levers adapted to dispense ice-cream from the dispenser nozzles.

In order to make it easier for the operators in charge of dispensing soft ice-cream, while reducing the height of said tower, the automatic machine is interrupted on top by a rather deep compartment exactly lying under the dispenser nozzles and used by the operator to insert his hand and hold the cone or cup to receive the ice-cream spirals further to the descending travel of the actuation levers.

In order to allow the user to see the flavors dispensed by the automatic machine of the invention, said refrigerated tanks with various mixtures are covered, at the height of the work top of the automatic machine, with panels made of glass, Plexiglas or other suitable transparent materials that are heated in order to prevent formation of condensation that might hinder the vision of the product contained in said tanks.

In this way, while approaching the ice-cream dispenser tower, the customer can see the contents of the tanks through said transparent panels and recognize the flavors available from the colors of the corresponding mixtures.

### BRIEF DESCRIPTION OF THE DRAWINGS

For explanatory reasons, the description of the automatic machine according to the present invention continues with reference to the attached drawings, which only have illustrative, not limiting value, wherein:

FIG. 1 is an axonometric view of a preferred embodiment of the automatic machine of the invention;

FIG. 2 is a diagrammatic side view of the configuration, including internally, of the operating parts of the automatic machine of FIG. 1;

FIG. 3 is a diagrammatic top view of the automatic machine of FIG. 1.

### DETAILED DESCRIPTION OF THE INVENTION

Referring to the aforementioned figures, the automatic machine (B) of the invention has a substantially parallelepiped empty structure, comprising a back side (P) for the operators in charge of ice-cream dispensing, and a front side (A) for customers.

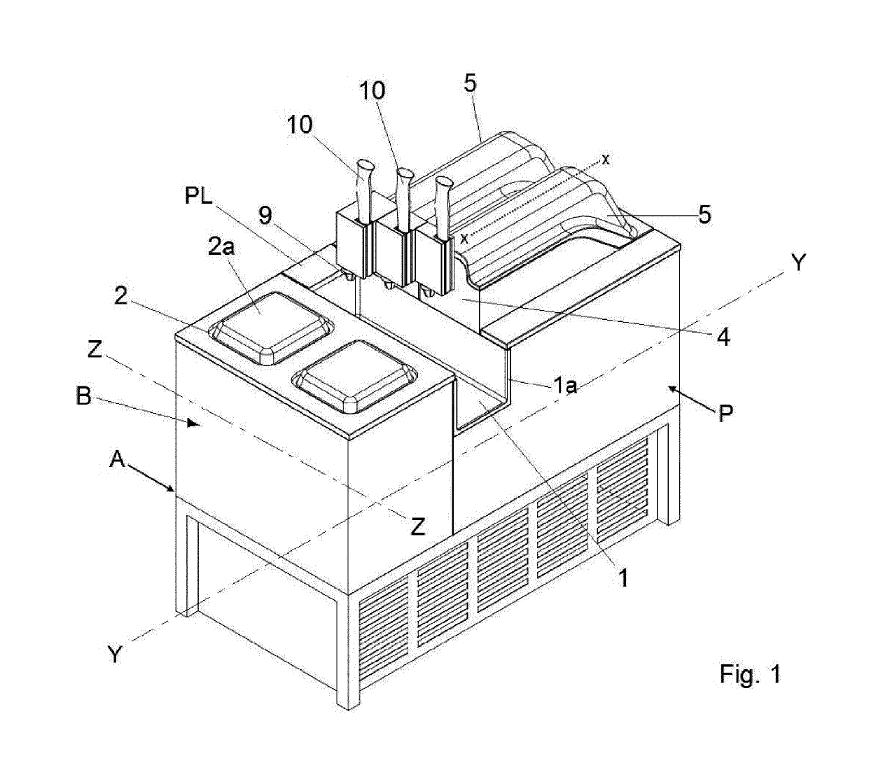

Referring to FIG. 1, the automatic machine (B) is provided with a work top (PL) with transversal direction (z-z) and longitudinal direction (y-y), which are mutually perpendicular.

Specifically, the transversal direction (z-z) extends from front side (A) to back side (P) of the automatic machine of the invention.

The work top (PL) of said automatic machine (B) is interrupted by a transversal compartment (1) with substantially rectangular shape, otherwise configurable as a lowered lane, extending perpendicularly with respect to said longitudinal direction (y-y) of the work top (PL).

As shown in FIG. 1, said transversal compartment (1) is accessed through an opening (1la) obtained on the back side (P) of the automatic machine (B).

On one side of said transversal compartment (1) tanks (2) are housed inside the automatic machine and adapted to contain mixtures of liquid pasteurized products for production of soft ice-cream.

Said tanks (2) are closed, at the height of said work top (PL), with transparent panels (2a) to make the contents of tanks (2) visible.

Moreover, said transparent panels (2a) are associated with electrical heating elements or other heating means, adapted to prevent formation of condensation that would reduce transparency and prevent vision of products contained inside said tanks (2).

Towards the bottom of said automatic machine (B), a refrigerating unit (3) is housed under said tanks, and adapted to provide the necessary low temperature to said tanks (2) and their content.

On the opposite side of said compartment (1) a tower (4) is mounted, housing in horizontal position whipping cylinders (5) with spiral configuration, of known type, effectively adapted to produce soft ice-cream.

In particular, the position of said whipping cylinders (5) is such that their longitudinal axis (x-x) lies on a vertical plane parallel to the longitudinal direction (y-y) of the work top (PL).

Preferably, said longitudinal axis (x-x) of the whipping cylinders (5) is horizontal.

A screw with horizontal axis (or worm screw) operates inside each whipping cylinder (5), being adapted to convert the mixture in substantially liquid state into a soft, creamy product.

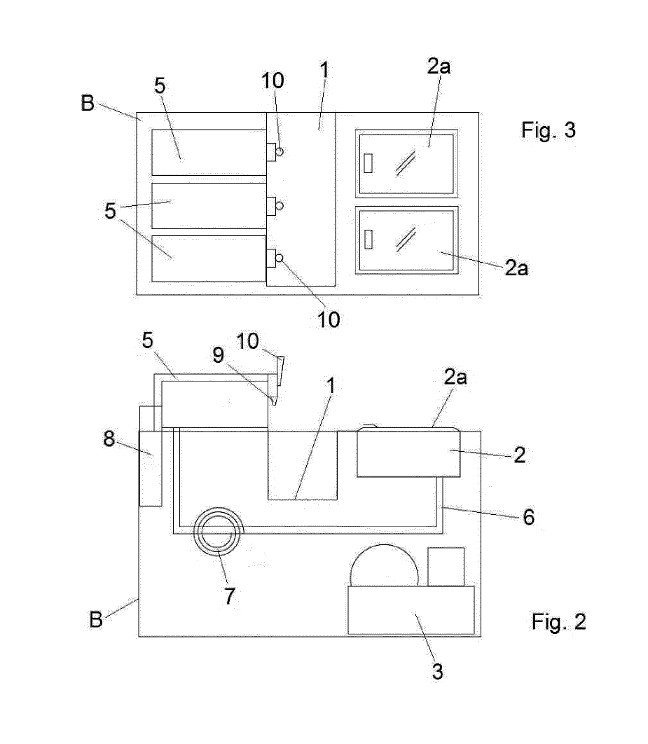

As shown in FIG. 2, in particular, said whipping cylinders (5) are connected with said refrigerated tanks (2) by means of ducts (6), likewise housed in the automatic machine (B), and suitably associated with a pump (7).

For the actuation of said screws, the automatic machine (B) of the invention houses an electrical motor (8) adapted to selectively and simultaneously drive into continuous rotation either one of said screws.

It must be considered that each of said whipping cylinders (5) is provided with a dispenser nozzle (9) disposed, together with its actuation lever (10), at one end of the whipping cylinder (5) and exactly above said transversal compartment (1) of the automatic machine (B).

In order to explain the operation of such an innovative device, it must be noted that the operator in charge of dispensing soft ice-cream will lower the actuation lever (10) that corresponds to the desired flavor.

In this way, the operator will enable the substantially simultaneous operation of some of said parts of the automatic machine (B).

First of all, reference is made to the electrical motor (8) that drives into rotation the screw that corresponds to the specific whipping cylinder (5) from which ice-cream must be dispensed.

The continuous rotation of said screw is used to whip the liquid mixture received into said whipping cylinder (5) and transfer the finished product towards the dispenser nozzle (9).

Through the dispenser nozzle (9), in fact, spirals of soft ice-cream are dispensed by simple gravity inside a cone or cup positioned by the operator under the dispenser nozzle, taking advantage of the presence of said transversal compartment (1).

The descending travel of said actuation lever (10) also produces the actuation of said pump (7) and guarantees the continuous refilling of the liquid mixture from said refrigerated tank (2) in favor of said whipping cylinder (5).

The release of said actuation lever (10) will interrupt the operation of the aforementioned moving parts, and instantaneously inhibit soft ice-cream dispensing through dispenser nozzle (9) and interrupt transfer of liquid mixture from tank (2) to whipping cylinder (5).

It must be noted that the innovative position with respect to the work top (PL), of the various parts of the “dispensing station”, i.e. dispenser nozzles (9), whipping cylinders (5) and housing tower (4), has allowed to dispose such a “dispensing station” in intermediate position between the operator working on the back of the automatic machine and the customer waiting on the front of the automatic machine.

Such a position ensures that, for the entire dispensing operation of soft ice-cream, the operator will look the customer waiting for ice-cream on the other side of the automatic machine (B) in the face.

Finally, it must be noted that, according to the preferred embodiment of the machine of the invention shown in FIG. 1, said actuation levers (10) are adapted to make alternate travels (from up down, and vice versa) along a vertical plane perpendicular to longitudinal direction (y-y) of the work top (PL) of the automatic machine.

More precisely, it must be noted that, upon actuation, each of said actuation levers (10) will be lowered towards said back side (P) of the automatic machine (B), in such way to facilitate the task of the operator in charge of dispensing, who is actually standing in such a position.

As shown in the same figure, the three actuation levers (10) provided in the automatic machine (B) lie on three different vertical planes side-by-side in staggered position to prevent them from mutual interference during the “up-down” travels and vice versa.

1. An automatic machine for production and dispensing of soft ice-cream, comprising:
a work top;
a back side for operators in charge of dispensing;
a front side for customers;
at least one refrigerated tank adapted to contain mixtures of liquid products for production of soft ice-cream;
a refrigerating unit adapted to maintain said at least one tank at low temperature;
at least one whipping cylinder with spiral configuration, connected to said at least one tank;
connection means between said at least one tank and said at least one whipping cylinder with spiral configuration;
at least one dispenser nozzle of said at least one whipping cylinder, adapted to dispense soft ice-cream;
an actuation lever of said at least one dispenser nozzle;
wherein the work top has a transversal direction (z-z) extends from the front side to the back side of the automatic machine and a longitudinal direction (y-y) perpendicular to the transversal direction (z-z),
said at least one whipping cylinder being provided with longitudinal axis (x-x) lying on a vertical plane parallel to said longitudinal direction (y-y) of said work top,
the automatic machine further comprises a transversal compartment that interrupts said work top deeply according to transversal direction (z-z) orthogonal to said longitudinal direction (y-y) of said work top, said transversal compartment being disposed under said at least one dispenser nozzle.

2. The automatic machine of claim 1, wherein said longitudinal axis (x-x) of said at least one whipping cylinder is horizontal.

3. The automatic machine of claim 1, wherein said refrigerated tanks are mounted under the work top of the automatic machine and said whipping cylinders (5) are mounted in a tower protruding upwards from the work top of the automatic machine.

4. The automatic machine of claim 1, wherein said refrigerated tanks are housed on one side of said transversal compartment and said whipping cylinders are housed in said tower mounted on the opposite side of said compartment.

5. The automatic machine of claim 1, comprising at least one transparent panel adapted to cover said at least one tank, said at least one tank being situated under said work top and said at least one transparent panel being substantially flush with said work top of said automatic machine.

6. The automatic machine of claim 5, wherein said at least one transparent panel is connected to heating means.

7. The automatic machine of claim 1, wherein said transversal compartment is provided with an opening obtained on a back side of said automatic machine.

8. The automatic machine of claim 1, wherein said actuation lever of said at least one dispenser nozzle is moved towards said back side of the automatic machine and inside a vertical plane perpendicular to the longitudinal direction (y-y) of the work top.

9. The automatic machine of claim 1 comprising a plurality of actuation levers of said at least one dispenser nozzle lying on vertical planes in mutually parallel staggered position.

10. The automatic machine of claim 1, herein said connection means between said at least one tank and said at least one whipping cylinder with spiral configuration consist in at least one duct associated with a pump.
